(19) United States
(12) Patent Application Publication
(10) Pub. No.: US 2008/0190867 A1
(43) Pub. Date: Aug. 14, 2008

(54) SYSTEM AND METHOD FOR TREATING WASTEWATER

(75) Inventors: Sin Chai Lin, Shanghai (CN); Yuan Hsin Peng, Shanghai (CN); Jiang Liu, Shanghai (CN); Jun Feng, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: SEMICONDUCTOR MANUFACTURING INTERNATIONAL (Shanghai) CORPORATION, Shanghai (CN)

(21) Appl. No.: 11/833,234

(22) Filed: Aug. 3, 2007

(30) Foreign Application Priority Data
Feb. 13, 2007 (CN) 200710037681.9

(51) Int. Cl. B01D 37/00; B01D 43/00

(52) U.S. Cl. 210/767; 210/172.1

(57) ABSTRACT

The present invention provides a system for treating wastewater produced during grinding and slicing in a semiconductor packaging process, comprising a collecting tank for collecting the wastewater produced during grinding and/or slicing in a semiconductor packaging process; a physical filtration device for separating the suspended materials from the wastewater by physical filtration, the physical filtration device being in fluid communication with the collecting tank; a receiving device for receiving the wastewater treated by the physical filtration device, and the receiving device being in fluid communication with the physical filtration device. The present invention further provides a method for treating wastewater produce during grinding and slicing in a semiconductor packaging process. The present invention simplifies the treatment of wastewater produced during grinding and slicing in a semiconductor packaging process, and lowers the cost.

### FIELD OF THE INVENTION

The present invention generally relates to semiconductor packaging and testing technique, and more particularly, to a system and method for treating wastewater produced during grinding and slicing in a semiconductor packaging and testing process.

### DESCRIPTION OF THE RELATED ART

In semiconductor fabrication, semiconductor chips with various functions are formed by a series of processes such as photolithography, etching, deposition, ion implantation, grinding and cleaning. Then the semiconductor chips are subjected to packaging and electrically testing, and finally are formed into end products. In view of cost and mass production, a semiconductor chip is usually fabricated on a silicon-based wafer. Currently, the diameter of semiconductor wafer generally is 200 or 300 mm. Prior to the step of packaging, the semiconductor wafer is reduced in thickness by grinding and then sliced off into chips. A great deal of industrial wastewater containing suspended silicon and trace abrasive is produced during the grinding and the slicing steps. In an existing wastewater treatment method, industrial wastewater together with plating wastewater is generally subjected to a chemical treatment which comprises pH adjusting, flocculating and sedimentation to remove suspended silicon, and then discharged after meeting certain regulations. The suspended silicon is transferred into sludge after the sedimentation. Chinese patent publication No. CN1623911A disclosed a system and method for treating wastewater, in which a chemically method and system for treating wastewater produced during back-grinding process for a semiconductor wafer was described.

FIG. 1 is a graphical illustration showing the system disclosed in CN1623911A. As shown in FIG. 1, the wastewater 10 produced during back-grinding the semiconductor wafer is delivered to a reaction tank 14. In the meantime, the wastewater produced by other process, such as the wastewater produced during Chemical Mechanical Polish (CMP) and the wastewater produced during washing the back side of wafer is also supplied to the reaction tank 14. That is, the wastewater produced during back-grinding the semiconductor wafer, the wastewater produced during Chemical Mechanical Polish (CMP) and other wastewaters are mixed in the reaction tank 14. Then, a polymer coagulant aid (for example FSC-835) for coagulation is introduced into the reaction tank 14. The coagulant aid is bonded with the particles in wastewater and is separated out after forming precipitation. The wastewater treated in the reaction tank 14 is introduced into a sedimentation tank 17 through an output pipeline 15. A polymer for coagulation 16 (for example EA-630) is introduced into the sedimentation tank 17 in order to bond with the remaining particles which did not bond with the coagulant aid. Then, the sludge in the sedimentation tank 17 is pumped out by using one or more pump 18. The treated wastewater in the sedimentation tank 17 is introduced into a discharge tank 19 in which the pH value of the wastewater is adjusted. Finally the treated wastewater is transferred into a recovering tank through a pipeline 20, a transfer pump 21 and a discharge pipeline 22.

The above-mentioned method for treating wastewater from the manufacturing and packaging of the semiconductor involves much chemical steps, and thus the system and process is complex and not cost-effective due to the fact of consuming a great deal of chemicals

### SUMMARY OF THE INVENTION

The present invention provides a simplified system and method for cost-effectively treating wastewater.

In the first aspect according to the present invention, there is provided a system for treating wastewater produced during grinding and slicing in a semiconductor packaging process, comprising a collecting tank for collecting wastewater produced during grinding and/or slicing in a semiconductor packaging process; a physical filtration device for separating suspended materials from the wastewater by physical filtration, the physical filtration device being in fluid communication with the collecting tank; and a receiving device for receiving the wastewater treated by the physical filtration device, the receiving device being in fluid communication with the physical filtration device.

Preferably, the collecting tank is in fluid communication with the physical filtration device through a pressure transferring device.

In one embodiment according to the present invention, the physical filtration device is one of a filter, a filtering machine and a filter press. Preferably, the physical filtration device is one of a chamber filter press, a belt filter press and a frame filter press or a combination thereof.

The filtration medium of the filter press may be a filtration fabric and/or a filtration membrane.

Preferably, the filtration medium of the filter press comprises a filtration fabric and a filtration membrane, the filtration fabric has a filtration aperture in a range of 0.5 to 10 μm, and the filtration membrane has a filtration aperture in a range of 0.1 to 1 μm.

In another embodiment according to the present invention, the physical filtration device is a filter, and the filtration medium of the filter is a filter element. Preferably, the filter element has a filtration aperture in a range of 0.1 to 10 μm.

In still another embodiment according to the present invention, the system further comprises a collecting device for collecting the suspended materials separated from the wastewater by the physical filtration device, the collecting device being disposed opposite to the physical filtration device; and a drying device for drying the suspended materials, the drying device being disposed opposite to the collecting device.

In the second aspect according to the present invention, there is provided a method for treating wastewater produced during grinding and slicing in a semiconductor packaging process, comprises the steps of collecting wastewater produced during grinding and/or slicing in a semiconductor packaging process; separating suspended materials from the wastewater by physical filtration; and collecting the wastewater treated by the physical filtration.

Preferably, the suspended materials comprise silicon.

In one embodiment according to the present invention, the filtration medium used in the physical filtration is one of a filtration fabric, a filtration membrane, a filter bag and a filter element or a combination thereof

The physical filtration may be one of a normal pressure filtration and a pressure filtration.

In another embodiment according to the present invention, the method further comprises the steps of filtering again the wastewater treated by the physical filtration and transferring the treated water into an industrial water system.

In still another embodiment according to the present invention, the method further comprises the steps of collecting the separated suspended materials and drying the suspended materials.

Compared with the existing technique, the present invention is advantageous in that:

The system according to the present invention comprises a collecting tank, a physical filtration device and a receiving device. The collecting tank is used for collecting the wastewater produced during the grinding and/or slicing treatments. The physical filtration device is used for filtering suspended materials from the wastewater. And the receiving device is used for receiving the wastewater filtered by the physical filtration device. The physical filtration device according to the present invention may filter the suspended materials from the wastewater and achieve the separation between the suspended materials and water. Compared with the wastewater treatment system in the existing technique, the system according to the present invention is simplified in the structure. During the wastewater treatment, the system according to the present invention completely depends on a physical procedure and needs not any chemicals to be added, thereby it cannot cause any chemical corrosion for each device in the system. According to the present invention, the service life of each device is prolonged and the cost is lowered.

The method according to the present invention needs not any chemicals to be added during the wastewater treatment, which makes the treatment simple and the cost lower. It does not introduce impurities into the suspended silicon and water after separation. The water treated by the system according to the present invention can be supplied for use again as industrial water and the separated silicon can also be delivered to a wafer factory for reuse.

### BRIEF DESCRIPTION OF THE DRAWINGS

FIG. 1 is a graphical illustration showing an existing wastewater treatment system;

FIG. 2 is a graphical illustration showing a system for treating wastewater produced during grinding and slicing in a semiconductor packaging process according to a first embodiment of the invention;

FIG. 3 is a graphical cross-section view showing the filtration chamber of the chamber filter press in the system shown in FIG. 2;

FIG. 4 is a graphical illustration showing a system for treating wastewater produced during grinding and slicing in a semiconductor packaging process according to a second embodiment of the invention;

FIG. 5 is a flow chart showing a method for treating wastewater produced during grinding and slicing in a semiconductor packaging process according to an embodiment of the invention.

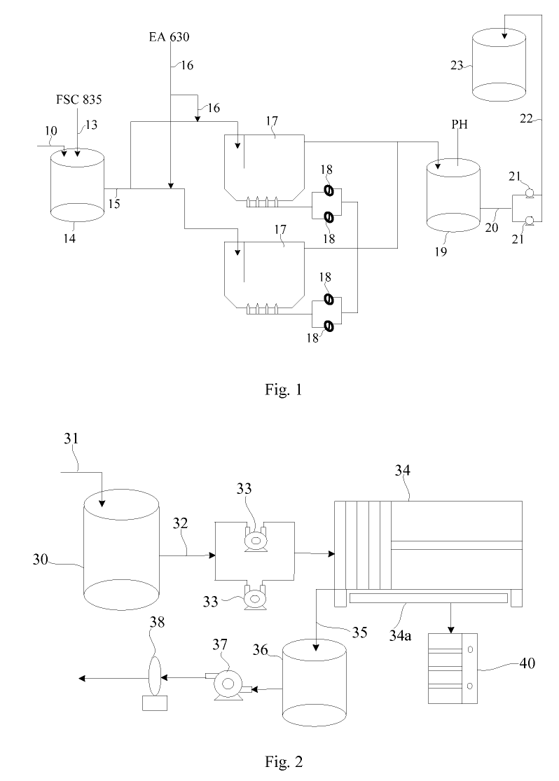

### SPECIFIC EMBODIMENTS OF THE INVENTION

Hereinafter, embodiments of the present invention will be described in detail with reference to the attached drawings.

It is necessary to grind the back side of a semiconductor wafer to reduce thickness and slice off a semiconductor chip from the semiconductor wafer before packaging the semiconductor chip. Then one or several semiconductor chips are subjected to packaging, making lead or testing. Back-grinding is a step in which a portion of silicon materials of the back side of a semiconductor wafer is removed by a grinding device. For example, a semiconductor wafer with a diameter of 300 mm which has a thickness in a range of 700 to 800 μm generally needs to be reduced to 200 to 400 μm in thickness before packaging. The slicing is a step in which a semiconductor chip is sliced off from a semiconductor wafer by using a slicing saw with a diamond blade. A great deal of wastewater containing suspended silicon will be produced both in the grinding step and in the slicing step. The present invention provides a system for treating the wastewater. The system comprises a collecting tank, a physical filtration device and a receiving device. The collecting tank is in fluid communication with the devices for grinding and/or slicing in the semiconductor packaging process, and is used for collecting the wastewater produced by the devices for grinding and/or slicing during operation. A fluid connecting conduit (or pipeline) is extended out from the collecting tank and connected with an inlet port of the physical filtration device. The wastewater in the collecting tank can flow into the physical filtration device through the fluid connecting conduit (or pipeline). The suspended materials in the wastewater are filtered out by the physical filtration device. The wastewater filtered by the physical filtration device is transferred into the receiving device through a connecting conduit (or pipeline) and is reused.

The physical filtration device may be one of a filter, a filtering machine and a filter press. The filter press may be one of a chamber filter press, a belt filter press and a frame filter press or a combination thereof The physical filtration device has a filtration medium which may be a filtration fabric, a filtration membrane, a filter element or a filter bag. The filtration aperture of the filtration medium is less than the size of the suspended materials. When the wastewater passes through the filtration medium, the suspended materials in the wastewater is screened by the filtration medium and settles down; thereby the separation between the suspended materials and water is achieved. The system according to the present invention may also comprise a further collecting device for collecting the suspended materials separated and filtered out by the physical filtration device.

The system according to the present invention can perform physical filtration on the wastewater produced during grinding and/or slicing in a semiconductor packaging process. The suspended silicon in the wastewater is separated from water by the filtration device, without the need of adding any consumable chemicals during the separation. Therefore, the cost is reduced. Furthermore it does not introduce new impurities into the separated silicon and the separated water. The water treated by the system according to the present invention can be supplied for use again as industrial water, and the separated silicon can also be delivered to a wafer factory for reuse.

Hereinafter, the system for treating the wastewater produced during grinding and slicing in a semiconductor packaging process according to the present invention will be described in detail with reference to the examples.

FIG. 2 is a graphical illustration showing a system for treating wastewater produced during grinding and slicing in a semiconductor packaging process according to a first embodiment of the invention.

As shown in FIG. 2, the wastewater treatment system comprises a collecting tank 30, a physical filtration device 34 and a receiving device 36. The collecting tank 30 is in fluid communication with a grinding device and/or a slicing device (not shown) in the semiconductor packaging process and is used for collecting the wastewater 31 produced by the grinding device and/or the slicing device during operation. The wastewater 31 contains the suspended silicon. A first fluid connecting conduit (or pipeline) 32 equipped with one or two pressure transferring devices 33 such as pump is extended out from the collecting tank 30. An outlet port of the pressure transferring device 33 is connected with an inlet port of the physical filtration device 34. The wastewater in the collecting tank 30 can be transferred into the physical filtration device 34 through the first fluid connecting conduit (or pipeline) 32 and the pressure transferring device 33. The suspended silicon in the wastewater is filtered out by the physical filtration device 34. In other examples, the first fluid connecting conduit 32 may not be equipped with the pressure transferring device 33, but is directly connected with an inlet port of the physical filtration device 34. Under the action of gravity and atmosphere pressure, the wastewater in the collecting tank 30 can be transferred into the physical filtration device 34 through the first fluid connecting conduit 32. The receiving device 36 is connected with an outlet port of the physical filtration device 34 through a second connecting conduit (or pipeline) 35. The wastewater filtered by the physical filtration device 34 can be discharged into the receiving device 36 via the second connecting conduit 35. In other examples, the second connecting conduit (or pipeline) 35 can be equipped with a pressure transferring device, which will be not described in detail here.

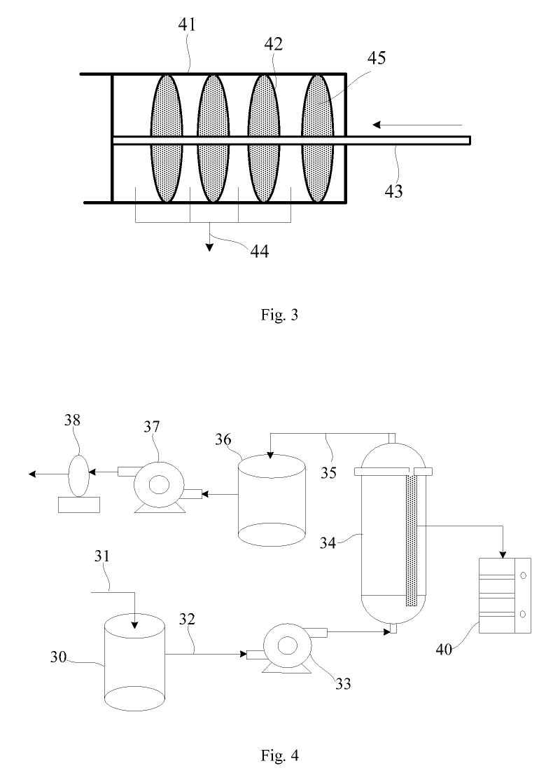

In this example, the physical filtration device 34 is a chamber filter press, in which the filtration medium comprises a filtration fabric having a filtration aperture in a range of 0.5 to 10 μm and a filtration membrane having a filtration aperture in a range of 0.1 to 1 μm. FIG. 3 is a graphical cross-section view showing a filtration chamber of the chamber filter press. As shown in FIG. 3, the filtration chamber 41 of the chamber filter press has close chambers consisting of filtration fabric or filtration membrane 42. The first fluid connecting conduit (or pipeline) 32 is connected with a conduit 43 through which the wastewater is fed into the close chambers. The filtration fabric or filtration membrane 42 is pressed by the pressure generated inside the chamber filter press, so that the space inside the chambers is reduced. The wastewater in the chambers is discharged through the pore on the filtration fabric or filtration membrane 42, then is delivered to the second fluid connecting conduit (or pipeline) 35 through an output conduit 44. Since the filtration aperture of the filtration fabric or filtration membrane 42 is less than the size of the suspended materials in the wastewater, the suspended materials 45 in the wastewater is screened and deposited in the chamber when the wastewater passes through the filtration fabric or filtration membrane 42. Thereby the separation between the suspended materials and water is achieved.

As shown in FIG. 2, the system according to this example can also comprise a collecting device 34a for collecting the suspended materials filtered out by the physical filtration device 34 and a drying device 40. The suspended materials are mainly silicon in this example. The drying device 40 is used for drying the silicon collected by the collecting device 34a and producing silicon powder. The dried silicon powder can be delivered to a wafer factory to be reused.

The wastewater in the receiving device 36 treated by the physical filtration device 34 can be delivered to an industrial water system to be reused through a transfer pump 37, or be delivered to an industrial water system for reuse through a filtration device 38.

The wastewater treatment system according to the present invention can perform physical filtration on the wastewater produced during grinding and/or slicing in a semiconductor packaging process. The suspended silicon in the wastewater is separated from water by the physical filtration device 34, without the need of adding any consumable chemicals during the separation. Therefore, the process is simplified and the cost is reduced. Furthermore it does not introduce new impurities into the separated silicon and the separated water. The water and silicon powder treated by the present invention can be reused.

FIG. 4 is a graphical illustration showing a system for treating wastewater produced during grinding and slicing in a semiconductor packaging process according to a second embodiment of the invention. As shown in FIG. 4, the wastewater treatment system comprises a collecting tank 30, a filtration device 34 and a receiving device 36. The collecting tank 30 is in fluid communication with a grinding device and/or a slicing device in the semiconductor packaging process and is used for collecting the wastewater 31 produced by the grinding device and/or the slicing device during operation. The wastewater 31 contains the suspended silicon. A first fluid connecting conduit (or pipeline) 32 equipped with pressure transferring devices 33 such as pump is extended out from the collecting tank 30. An outlet port of the pressure transferring device 33 is connected with an inlet port of the physical filtration device 34. The wastewater in the collecting tank 30 can be transferred into the physical filtration device 34 through the first fluid connecting conduit (or pipeline) 32 and the pressure transferring device 33. The suspended silicon in the wastewater is filtered out by the physical filtration device 34. The receiving device 36 is connected with an outlet port of the physical filtration device 34 through a second connecting conduit (or pipeline) 35. The wastewater filtered by the physical filtration device 34 can be discharged into the receiving device 36 via the second connecting conduit 35. In this example, the physical filtration device 34 is a filter in which the filtration medium is a filter element made of titanium alloy. The filtration aperture of the filter element is in a range of 0.1 to 10 μm.

The system according to this example can also comprise a drying device 40 for drying silicon produced by the filtration. The dried silicon can be delivered to a wafer factory for reuse. The wastewater in the receiving device 36 treated by the physical filtration device can be delivered to an industrial water system to be reused through a transfer pump 37, or be delivered to an industrial water system for reuse through a filtration device 38.

The present invention further provides a method for treating wastewater produced during grinding and slicing in a semiconductor packaging process. In the method according to the present invention, the wastewater containing suspended materials is collected; then the suspended materials are separated from the wastewater by a physical filtration for the purpose of solid-liquid separation. The wastewater treated by the separation device can be used as industrial water and the separated suspended silicon can be reused after drying. The wastewater is treated by the physical filtration according to the present invention. And thus the method is simple and the cost is lower.

Hereinafter, the method for treating wastewater according to the present invention will be described with reference to the examples.

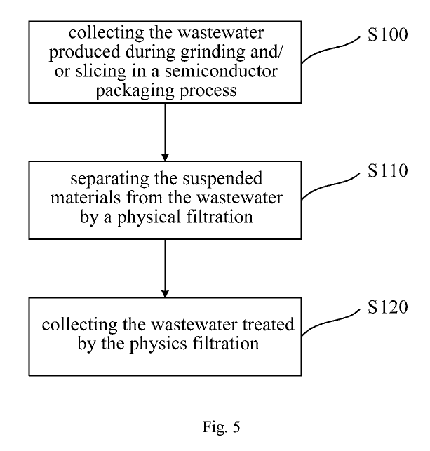

FIG. 5 is a flow chart showing a method for treating wastewater according to an example of the present invention.

As shown in FIG. 5, the wastewater produced during grinding and/or slicing in a semiconductor packaging process is collected (S100). A collecting tank is connected with a grinding device and/or a slicing device through a fluid connecting conduit. The wastewater produced by the grinding device and/or slicing device during operation is maintained in the collecting tank temporarily. The suspended materials in the wastewater are mainly silicon.

Then, the suspended materials are separated from the wastewater by a physical filtration (S110). Namely, the wastewater containing suspended materials passes through a filtration medium with the size of filtration aperture less than that of the suspended materials. Thus the suspended materials in the wastewater are screened by the filtration medium to separate the suspended materials from the wastewater. The filtration medium may be one of a filtration fabric, a filtration membrane, a filter bag and a filter element or a combination thereof. The physical filtration may be a normal pressure filtration or a pressure filtration.

In this example, a chamber filter press is used as a filtration device, in which the filtration medium comprises a filtration fabric having a filtration aperture in a range of 0.5 to 10 μm and a filtration membrane having a filtration aperture in a range of 0.1 to 1 μm. The wastewater held temporarily in the collecting tank is transferred into an inlet port of the chamber filter press through a fluid connecting conduit and a pressure transferring device arranged on the fluid connecting conduit. The silicon in the wastewater is filtered out through the filtration fabric and filtration membrane in the chamber filter press. In other examples, a filter or a filtering machine can be used as the filtration device to carry out the physical filtration, which will be not described in detail here.

Then, the wastewater treated by the physics filtration is collected in a receiving device (S120), for example a receiving tank. The treated water is delivered to an industrial water system.

The method according to the present invention further comprises collecting the silicon produced by the physical filtration, and delivering the collected silicon to a wafer factory for reuse after drying.

While the present invention has been described with respect to certain preferred embodiments, it will be apparent to those skilled in the art that various changes and modifications may be made without departing from the spirit and scope of the invention as defined in the following claims.

1. A system for treating wastewater produced during grinding and slicing in a semiconductor packaging process, comprising:
a collecting tank for collecting wastewater produced during grinding and/or slicing in a semiconductor packaging process;
a physical filtration device for separating suspended materials from the wastewater by physical filtration, the physical filtration device being in fluid communication with the collecting tank; and
a receiving device for receiving the wastewater treated by the physical filtration device, the receiving device being in fluid communication with the physical filtration device.

2. The system for treating wastewater produced during grinding and slicing in a semiconductor packaging process as claimed in claim 1, wherein the physical filtration device is one of a filter, a filtering machine and a filter press.

3. The system for treating wastewater produced during grinding and slicing in a semiconductor packaging process as claimed in claim 1, wherein the physical filtration device is one of a chamber filter press, a belt filter press and a frame filter press or a combination thereof.

4. The system for treating wastewater produced during grinding and slicing in a semiconductor packaging process as claimed in claim 3, wherein 4 a filtration medium of the filter press is a filtration fabric and/or a filtration membrane.

5. The system for treating wastewater produced during grinding and slicing in a semiconductor packaging process as claimed in claim 3, wherein 4 a filtration medium of the filter press comprises a filtration fabric and a filtration membrane, wherein the filtration fabric has a filtration aperture in a range of 0.5 to 10 μm, and wherein the filtration membrane has a filtration aperture in a range of 0.1 to 1 μm.

6. The system for treating wastewater produced during grinding and slicing in a semiconductor packaging process as claimed in claim 1, wherein the physical filtration device is a filter, and wherein a filtration medium of the filter is a filter element.

7. The system for treating wastewater produced during grinding and slicing in a semiconductor packaging process as claimed in claim 6, wherein the filter element has a filtration aperture in a range of 0.1 to 10 μm.

8. The system for treating wastewater produced during grinding and slicing in a semiconductor packaging process as claimed in claim 1, further comprising:
a collecting device for collecting the suspended materials separated from the wastewater by the physical filtration device, the collecting device being disposed opposite to the physical filtration device; and
a drying device for drying the suspended materials, the drying device being disposed opposite to the collecting device.

9. The system for treating wastewater produced during grinding and slicing in a semiconductor packaging process as claimed in claim 1, wherein the collecting tank is in fluid communication with the physical filtration device through a pressure transferring device.

10. A method for treating wastewater produced during grinding and slicing in a semiconductor packaging process, the method comprising the steps of:
collecting wastewater produced during grinding and/or slicing in a semiconductor packaging process;
separating suspended materials from the wastewater by physical filtration; and
collecting the wastewater treated by the physical filtration.

11. The method for treating wastewater produced during grinding and slicing in a semiconductor packaging process as claimed in claim 10, wherein the suspended materials comprise silicon.

12. The method for treating wastewater produced during grinding and slicing in a semiconductor packaging process as claimed in claim 10, wherein a filtration medium used in the physical filtration is one of a filtration fabric, a filtration membrane, a filter bag and a filter element or a combination thereof.

13. The method for treating wastewater produced during grinding and slicing in a semiconductor packaging process as claimed in claim 10, wherein the physical filtration is one of a normal pressure filtration and a pressure filtration.

14. The method for treating wastewater produced during grinding and slicing in a semiconductor packaging process as claimed in claim 10, further comprises the steps of filtering again the wastewater treated by the physical filtration and transferring the treated water into an industrial water system.

15. The method for treating wastewater produced during grinding and slicing in a semiconductor packaging process as claimed in claim 10, further comprises the steps of collecting the separated suspended materials and drying the suspended materials.
